(19) United States
(12) Patent Application Publication
(10) Pub. No.: US 2017/0185906 A1
(43) Pub. Date: Jun. 29, 2017

(54) System and Method for Determining Machine Operational State

(71) Applicant: CATERPILLAR OF AUSTRALIA PTY LTD, Tullamarine (AU)

(72) Inventor: Darryl V. Collins, Jindalee (AU)

(73) Assignee: Caterpillar of Australia Pty Ltd, Tullamarine (AU)

(21) Appl. No.: 15/325,214

(22) PCT Filed: Jul. 10, 2015
(86) PCT No.: PCT/AU2015/050391

§ 371 Date: Jan. 10, 2017

(30) Foreign Application Priority Data
Jul. 11, 2014 (AU) 2014203829

(51) Int. Cl. G06N 7/00; G07C 5/08

(52) U.S. Cl. CPC G06N 7/005; G07C 5/0841

(57) ABSTRACT

A computer-implemented method for estimating an actual operational state of a machine of interest at a point in time is described. The method comprises operating a computer processing unit to receive a plurality of messages, each message comprising data relating to the machine of interest as it performs the worksite operation. The plurality of messages comprises data from at least two separate sources. The data is processed using a statistical process to generate an estimated actual operational state of the machine of interest at the point in time.

### TECHNICAL FIELD

The present disclosure relates to systems and methods for determining the operational state of a machine in a worksite. The disclosure is particularity suitable for implementation in mining worksites and will be described in relation to that exemplary but non-limiting application.

### BACKGROUND

Worksites are operated with one or more goals in mind. In order to achieve those goals, worksites use machines to perform various operations, with different operations typically involving a number of different operational states.

For example, a goal of mining worksites is to yield ore. One typical mining operation, therefore, is the transport of excavated material. For example, in open-cut mines material is excavated from worksite locations (e.g. faces) and loaded into haulage machines for transport to a designated dumping or processing area. In the course of this broad operation, machines pass through various operational states. For example, a haulage machine (in the operation of transporting material from where it is excavated to where it is stockpiled or processed) will typically pass through the operational states of: travelling empty to a loading site, queuing at the loading site, spotting, being loaded, travelling full to a dumping site, queuing at the dumping site, and dumping.

Accurately determining the particular operational state a machine is in can be useful. Such operational state information can be used to monitor/assess machine productivity, monitor/assess machine operator performance/productivity, estimate worksite productivity, detect or anticipate abnormal machine or worksite conditions.

U.S. Pat. No. 8,364,440, titled “System for evaluating the productivity of a working machine and its driver” describes identifying different work cycles of a working machine based on the use of the controls by the driver of the working machine (i.e. by the driver's use of the working machine's control stick).

In large working environments, however, difficulties with worksite communications can exist. For example, worksite machine sensors can be broken or faulty and/or clocks on different worksite machines may not be synchronised. Further, communications across the worksite can be variable, particularly where machines operate in worksite locations with poor coverage, which can lead to communications going missing, arriving out of time, being duplicated, and/or being corrupted. Such issues can impede the ability to accurately estimate machine operational states.

### SUMMARY

Disclosed herein is a computer-implemented method for estimating an actual operational state of a machine of interest at a point in time, the machine of interest being involved in a worksite operation comprising a plurality of different operational states, wherein the method comprises operating a computer processing unit to: receive a plurality of messages, each message comprising data relating to the machine of interest as it performs the worksite operation, the plurality of messages comprising data from at least two separate sources; process the data from the plurality of messages using a statistical process to generate an estimated actual operational state of the machine of interest at the point in time.

The at least two separate data sources may comprise a first data source comprising data derived from a first sensor carried by the machine of interest and a second data source comprising data derived from a second sensor carried by the machine of interest.

The at least two separate data sources comprise a first data source comprising data derived from the machine of interest and a second data source comprising data derived another worksite machine.

The at least two separate data sources comprise a data source of contextual information.

The plurality of messages may comprise at least one perceived state message comprising data relating to a perceived operational state of the machine of interest at a point in time.

The source of the at least one perceived state message may be the machine of interest.

The computer-implemented method may further comprise operating the computer processing unit to: process the estimated actual operational state against alert criteria; and responsive to the alert criteria being satisfied, raise an alert comprising at the estimated actual operational state of the machine of interest.

The computer-implemented method may further comprise operating the computer processing unit to: process the plurality of operation messages using the statistically based process to generate uncertainty information associated with the estimated actual operational state of the machine of interest at the point in time, the uncertainty information defining an uncertainty with respect to the estimated actual operational state of the machine of interest at the point in time, and wherein the uncertainty information associated with the estimated actual operational state is used in the processing of the estimated actual operational state against the alert criteria.

The computer processing unit may be operated to: receive the plurality of messages in real time; and process the plurality of messages in real time such that the estimated actual operational state of the machine of interest is generated in real time.

The computer implemented method may further comprise operating the computer processing unit to: generate a computational model of the worksite operation, the computational model comprising the plurality of different operational states and plurality of observations relevant to the plurality of operational states, wherein each of the plurality of messages comprises data relating to an observation, and wherein processing the data from the plurality of messages using the statistical process comprises processing the data using the computational model to estimate the actual operational state of the machine of interest.

The computer-implemented method may further comprise operating the computer processing unit to train the computational model using a training dataset.

The computational model may comprise a Hidden Markov Model and the operational states may be hidden states of the Hidden Markov Model.

Processing the data from the plurality of messages using the statistical process may comprise using a Viterbi Algorithm to process the data using the computational model to estimate the actual operational state of the machine of interest.

The worksite process may comprise operating haulage machines to haul material from a loading location to a dumping location, and the machine of interest may a particular haulage machine.

The plurality of different operational states may comprise: the machine of interest queuing at a loading location; the machine of interest spotting; the machine of interest loading; the machine of interest travelling full; the machine of interest queuing at a dumping location; the machine of interest dumping; the machine of interest travelling empty.

Also disclosed herein is a computer processing system configured to estimate an actual operational state of a machine of interest at a point in time, the machine of interest being involved in a worksite operation comprising a plurality of different operational states, the computer processing system configured to: receive a plurality of messages, each message comprising data relating to the machine of interest as it performs the worksite operation, the plurality of messages comprising data from at least two separate sources; operate a processing unit to process the data from the plurality of messages using a statistical process to generate an estimated actual operational state of the machine of interest at the point in time.

Also disclosed herein is a non-transitory computer-readable medium comprising instructions which, when implemented by a computer processing system, cause the computer processing system to estimate an actual operational state of a machine of interest at a point in time, the machine of interest being involved in a worksite operation comprising a plurality of different operational states, the instructions causing the computer processing system to: receive a plurality of messages, each message comprising data relating to the machine of interest as it performs the worksite operation, the plurality of messages comprising data from at least two separate sources; process the data from the plurality of messages using a statistical process to generate an estimated actual operational state of the machine of interest at the point in time.

As used herein, the term “comprises” (and grammatical variants thereof) is used inclusively and does not exclude the existence of additional features, elements or steps.

### BRIEF DESCRIPTION OF THE DRAWINGS

Various aspects and features will be described with reference to the following figures which are provided for the purposes of illustration and by way of non-limiting example only.

FIG. 1 is a pictorial illustration of an example worksite and control centre;

FIG. 2 is a block diagram of computer processing systems used in the worksite and control centre of FIG. 1;

FIG. 3 is a flow diagram illustrating a computer implemented method for generating and training a computational model;

FIG. 4 is a visual depiction of a computational model generated according to the process of FIG. 3;

FIG. 5 is a flow diagram illustrating a computer implemented method for using the computational model generated and trained according to the method of FIG. 3;

FIGS. 6 to 9 are graphs depicting results of the method of FIG. 5.

### DETAILED DESCRIPTION

### Worksite Environment

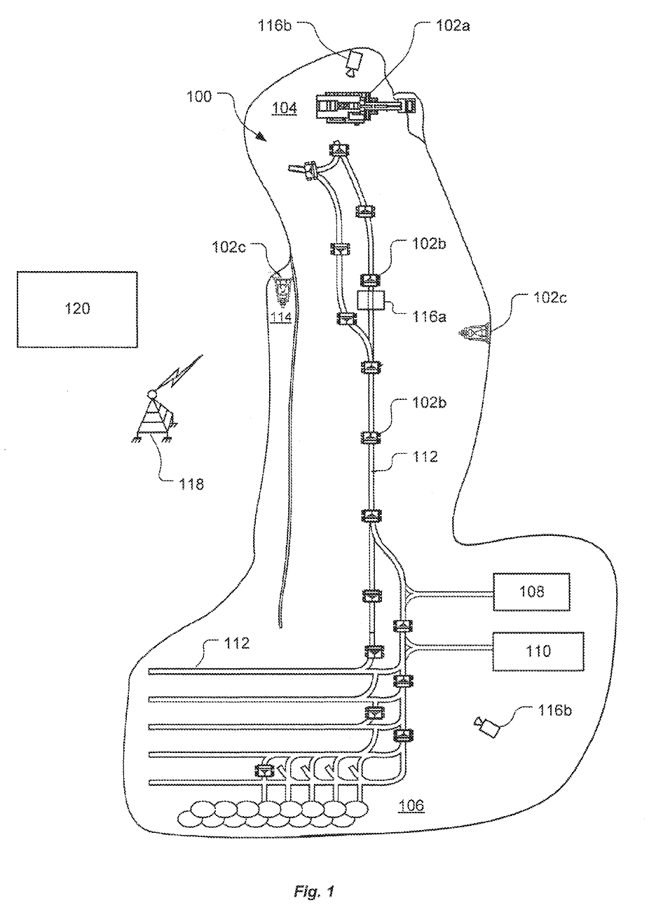

FIG. 1 illustrates a worksite 100 which, in the present example, is a mine worksite.

A number of machines 102 work on or at worksite 100. In this instance the machines 102 depicted comprise a loading machine 102a, haulage machines 102b, and levelling machines 102c (e.g. dozing or grading machines). Machines 102 operating at the worksite 100 may be directly controlled by human operators, remotely controlled by human operators, be autonomous machines capable of autonomously working and traversing the worksite 100, or be semi-autonomous machines configured to perform some functions autonomously and other functions under the control of an operator.

Worksite 100 also comprises a number of locations designated for particular purposes. In this example the locations comprise: a loading location 104 designated as a location at which a loading machine 102a or other resource operates to fill haulage machines 102b with material; a dump location 106 designated as a location at which haulage machines 102b drop collected material; a refuelling location 108 designated as a location which mobile machines can attend to be refuelled; and a maintenance location 110 designated as a location which mobile machines can attend to be maintained. Worksite 100 also comprises designated roads or paths 112 (each of which may have multiple lanes) linking various worksite locations and along which mobile worksite machines can travel.

Worksite 100 may also comprise various dedicated monitoring systems 116 which perform worksite monitoring. For example, worksite 100 is depicted with a weigh bridge 116a (which can weigh machines 102 as they traverse the bridge 116a) and a dedicated worksite camera 116b which captures visual data (still or video) of an area of the worksite 100.

Worksite 100 also comprises a radio communications tower 118 operated to relay messages between various worksite machines 102, monitoring systems 116, and a control centre 120. Control centre is shown in this in this instance as being remote from the worksite 100, however could equally be situated on the worksite 100. A given worksite 100 may well have a number of radio communications towers 118 to increase communications coverage and reliability over the worksite 100.

It will be appreciated that the types of machines 102, monitoring equipment 116, designated locations 104, 106, 114 described above are by way of illustration only. A given worksite may well have additional (or fewer) machines 102 and/or monitoring equipment 116, different types of machines 102 and/or monitoring equipment 116, and/or different designated locations.

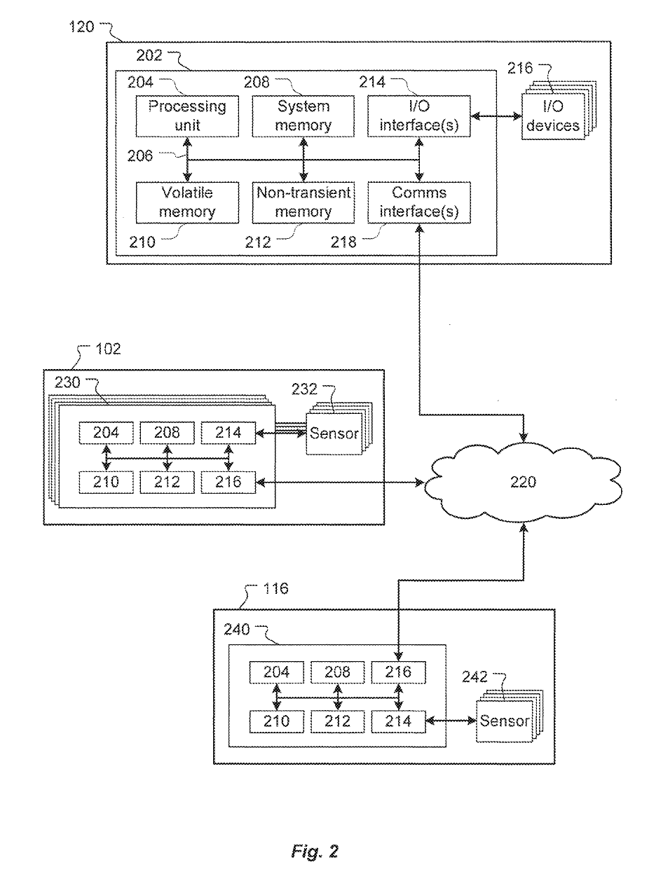

Turning to FIG. 2, a block diagram depicting computer processing systems used within the worksite 100 and control centre 120 is provided.

Generally speaking, the control centre 120 performs a central monitoring and control function for the worksite 100. This function is achieved by receiving information in respect of the worksite, processing it, and managing worksite operations accordingly. To enable this control centre 120 is provided with a computer processing system 202.

Computer processing system 202 (in the present example) comprises at least one processing unit 204 which may be a single computational processing device (e.g. a microprocessor or other computational device) or a plurality of computational processing devices. Through a communications bus 206 the processing unit 204 is in data communication with a system memory 208 (e.g. a read only memory storing a BIOS for basic system operations), volatile memory 210 (e.g. random access memory such as one or more DRAM modules), and non-transient memory 212 (e.g. one or more hard disk drives, solid state drives, flash memory devices and suchlike). Instructions and data for controlling operation of the processing unit 204 are stored on the system, volatile, and/or non-transitory memory 208, 210, and 212.

The computer processing system 202 also comprises one or more input/output interfaces 214 which allow the system 202 to interface with a plurality of input/output devices 216. As will be appreciated, a wide variety of input/output devices may be used, for example keyboards, pointing devices, touch-screens, touch-screen displays, displays, microphones, speakers, hard drives, solid state drives, flash memory devices and the like. Computer processing system 202 also comprises one or more communications interfaces 218, such as a Network Interface Card, allowing for wired or wireless connection to a communications network 220 (e.g. the Internet, a local area network, or a wide area network) and communication with other computer processing systems connected to the network 220.

Communication with the communications network 220 (and other devices connected thereto) will typically be by the protocols set out in the layers of the OSI model of computer networking. For example, applications/software programs being executed by the computer processing system 202 may communicate using one or more transport protocols, e.g. the Transmission Control Protocol (TCP, defined in RFC 793) or the User Datagram Protocol (UDP, defined in RFC 768). Alternative communications protocols may, of course, be used.

The computer processing system 202 stores in memory and runs one or more applications allowing operators to operate the device system 202. Such applications will typically comprise at least an operating system such as Microsoft Windows®, Apple OSX, Unix, or Linux.

Each worksite machine 102 is also equipped with at least one, and typically multiple, computer processing system(s) 230. Often, a given machine 102 will be equipped with multiple processing systems for performing multiple tasks. For example, a machine 102 may be equipped with a machine vital information management system (e.g. VIMS system as provided by Caterpillar™), a dedicated payload monitoring system, a dedicated tyre pressure monitoring system, and an operator display/control system. Each of these systems may be interconnected so as to be able to communicate with each other and/or be configured to communicate independently with an external system (e.g. with control centre 120 via network 220). For ease of reference the various computer processing systems of machines 102 will simply be referred to as machine computer processing system 230, but it will be appreciated from the foregoing that machine processing system 230 may, in fact, be multiple independent or interconnected processing systems. The computer processing system(s) 230 of each machine 102 may be similar in some respects to computer processing system 202 described above, though will typically be a dedicated system tailored specifically for the machine and/or operation in question. Worksite machines 102 are also typically equipped with a plurality of sensors 232 which may be integral with the various computer processing systems of the machine 102, or be separate components that interface with computer processing system(s) 230 of the machine, for example via input/output interfaces 214. The sensors 232 for a given machine typically comprise a number of different types of sensors (and, at times, multiple sensors of the same type) which are operated to sense and detect information regarding the operation of the machine and, in some cases, the environment proximate to the machine.

By way of non-limiting example, the sensors 232 for a machine 102 may comprise: a Global Positioning System (GPS) device, an Inertial Measurement Unit (IMU), radar, lidar, range sensors, video cameras, a fuel level sensor, a fuel pump sensor, payload load sensors, tyre pressure sensors, temperature sensors, a speed sensor, a gear sensor, tool position and/or orientation sensors (e.g. detecting for a haulage machine 102b whether the tray/bed is up or down, or detecting in a loading machine 102a the orientation/position of the dipper). In addition, machines 102 are typically equipped with more sophisticated sensor/monitoring systems (each of which may, for example, be an independent or interconnected computer processing system as discussed above) for monitoring major machine subsystems such as: machine engine; machine transmission; machine suspension; machine tyres; machine steering; machine exhaust; machine electrical and suchlike.

Typically, the sensors 232 of a given machine are controlled by and communicate sensed data to the computer processing system 230 of the machine. The computer processing system 230 processes the raw sensed data to generate predefined messages for transmission to the control centre 120 either in real-time or batch mode. For example, the computer processing system 230 of a machine 102 may periodically process available positional data (obtained, for example, from the GPS, IRU, and any other positional sensors) and generate a position report message reporting on the machine's position in the worksite 100. These messages are then transmitted to the computer processing system 202 of the control centre 120 (and, optionally, stored on a local memory of the computer processing system 230 of the machine 102). Messages between machines 102 and the control centre 120 are discussed in further detail below.

The computer processing system 230 of each machine 102 also enables the machine 102 to receive messages from the control centre 120 (e.g. via a communications interface 218). These messages can comprise, for example, task assignment messages with instructions which define new tasks (or modifying existing tasks) for the machine 102. Such messages can be displayed or otherwise imparted to an operator of the machine 102 (e.g. via output devices such as displays or and or speakers), or where the new/amended task can be carried out without operator intervention be processed by the computer processing system 230 for automatic implementation by the machine 102.

Each dedicated monitoring system 116 of the worksite 100 will also be equipped with (or be) a computer processing system 240. As with the worksite machines 102, the computer processing system 240 of a given monitoring system 116 will be similar in some respects to computer processing system 202 described above, and has been depicted that way in FIG. 2. Once again, however, the computer processing system 240 of a dedicated monitoring system 116 will normally be specifically tailored for that monitoring system and may comprise alternative components. Each dedicated monitoring system 116 will comprise at least one sensor 242 the type of which will depend on the purpose of the monitoring system 116. For example, a weigh bridge such as 116a may comprise a plurality of load sensors, while a worksite camera such as 116b may comprise an image capture sensor (such as a CCD or COMS sensor).

As with the worksite machines 102 described above, the sensors 242 of a given monitoring system are controlled by and communicate sensed data to the computer processing system 240, which can then communicate the sensed data to the computer processing system 202 of the control centre 120.

It will be appreciated that the foregoing example of the control centre 118 computer processing system 202 (referenced also in the context of machines 102 and monitoring systems 116) is provided by way of non-limiting example only. A wide variety of digital processing systems with different components and/or architectures could be used for either the control centre 120, individual machines 102, and/or individual monitoring systems 116.

In addition, although only one vehicle 102 and one monitoring system 116 are depicted in FIG. 2 the worksite 100 will, of course, have multiple vehicles 102 and monitoring systems 116 which communicate data with the computer processing system 202 of the control centre 120.

### Worksite Messages and Information

As noted above, during operation of the worksite 100 information is collected from a wide variety of sensors. Messages (which will be referred to as incident messages) are communicated to the computer processing system 202 of the control centre 120. To illustrate the number of messages (and amount of data) being processed, and recognising that all worksites are, of course, different, a typical open cut mine worksite may cover an area of up to (or over) 100 square kilometres and have 1000 or more machines operating simultaneously. By way of estimate, half of the machines may be “heavy” machines (such as loaders, dozers, graders, haulage trucks, draglines and the like), and half or the machines may be “light” machines (e.g. transportation vehicles and suchlike). Each machine may send approximately 1 to 2 messages per second, which can provide for the generation of up to (or over) 2000 incident messages per second.

At the computer processing system 202 of the control centre 120 incident messages (or, at least, the information communicated by the incident messages) are stored in one or more databases maintained, for example, in non-volatile memory 212. The information from the incident messages is made available for use (e.g. access) by programmatic applications and human operators in order to perform various worksite management functions.

A number of issues with the data gathered from the worksite can exist. Such issues can arise, for example, from: broken sensors leading to expected incident messages not being received; faulty or miscalibrated sensors leading to incident messages comprising inaccurate information; incident messages becoming corrupted; incident messages being delayed; incident messages being received out of order; incident messages being duplicated.

Further issues can arise where incident messages report seemingly contradictory information. For example, in the worksite 100 multiple machines 102 may report on a shared activity from different perspectives. As one simple example, a loading machine 102a may report that it is currently loading a particular haulage machine 102b. A different haulage machine, however, may report that it is currently loading. This generates a mismatch between the observations of the loading machine and haulage machines, making it difficult to determine which particular haulage machine is actually being loaded.

As another example, a loading machine 102a may send an incident message reporting the commencement of a loading operation at a certain time t1, a haulage machine 102b which is (in reality) receiving the material from the loading machine 102a may send an incident message reporting the commencement of the loading operation at an alternative time t2, and a camera monitoring system 116b may send visual data that depicts the loading operation in question commencing at a further alternative time t3.

This, in turn, illustrates a more general issue that can arise with worksite information. Time is often a useful dimension for sorting and analysing data (i.e. the chronological sequence of operations that have occurred/are occurring at the worksite). Given the number of machines 102 and monitoring systems 116 operating at the worksite it is generally the case that the internal clocks of various machines 102 and/or monitoring systems 116 are not synchronised. This can complicate the task of trying to generate an accurate timeline of worksite activity and events.

### Worksite Operations and Operational State Information

On order to run worksite 100, machines 102 are assigned with a variety of high-level operations. Such operations may comprise, for example, operations directed at altering the geography of the worksite 100, operations directed at recovering material from the worksite, operations directed at maintaining the worksite and so forth.

For example one operation may be a material transport operation, involving the transport of material from one location (e.g. the loading location 104) to another (e.g. the dump location 106). From the perspective of a loading machine 102a this operation generally comprises the operational states of: awaiting the arrival/positioning of a haulage machine 102b; collecting material at the loading location 104; loading the collected it into haulage machines 102b. From the perspective of hauling machines 102b, this operation generally involves attending/queuing at the loading location 104, manoeuvring into position to receive a load of material from a loading machine 102a, traversing roads 112 with a full load to the dump location 106, dumping the load of material at the dump location 106, and traversing roads 112 empty back to the loading location 104.

Information as to the particular operational state of a specific machine 102 at a given time is recorded by system 202 (e.g. in a suitable data structure on memory such as non-transient memory 212). This information is useful as it can be analysed to generate information relevant to the performance of the worksite 100, the performance of individual worksite operators/machines, operational faults of worksite machines, and/or worksite conditions.

To this end, certain worksite machines 102 (e.g. haulage machines 102b) are configured to estimate their own current operational states (i.e. a self-perceived state) and communicate messages comprising those self-perceived states to the control centre 120. Due to the problems described above, however, such estimates may not always be accurate—i.e. the self-perceived operational state of a given machine 102 may not match is actual operational state. Further, and whether a machine's operational state estimate is accurate or not, operational sate messages may go missing, be corrupted, have inaccurate time-stamps, and/or be delivered out of order.

### INDUSTRIAL APPLICABILITY

To assist in more accurately determining the operational states of machines 102, system 202 of the control centre 120 is configured to receive a plurality of incident messages from various machines 102 and process those message using a statistically based method in order to provide a more accurate estimate of the operational state of the particular machine 102.

In one embodiment the configuration of system 202 is achieved by software which comprises instructions which can be executed by a processing unit 204 to implement the relevant features of the method. The software/instructions will typically be stored on a non-transient computer-readable medium, such as a non-transient memory 212 or an external data storage device which can interface with the computer processing system 202 via, for example, an input/output interface 214. The software/instructions may be provided to computer processing system 202 by means of a data signal in a wired or wireless transmission channel over communications interface 218. In alternative embodiments the system may be implemented as hardware circuitry configured to implement the processes described.

In order to describe the principles of the disclosure, the example of estimating the operational state of a haulage machine 102b during a material transport operation will be described. It will be appreciated, however, that the principles could equally be applied in order to estimate the operational states of other machines involved in the material transport operation, and/or the operational states of machines 102 involved in alternative operations.

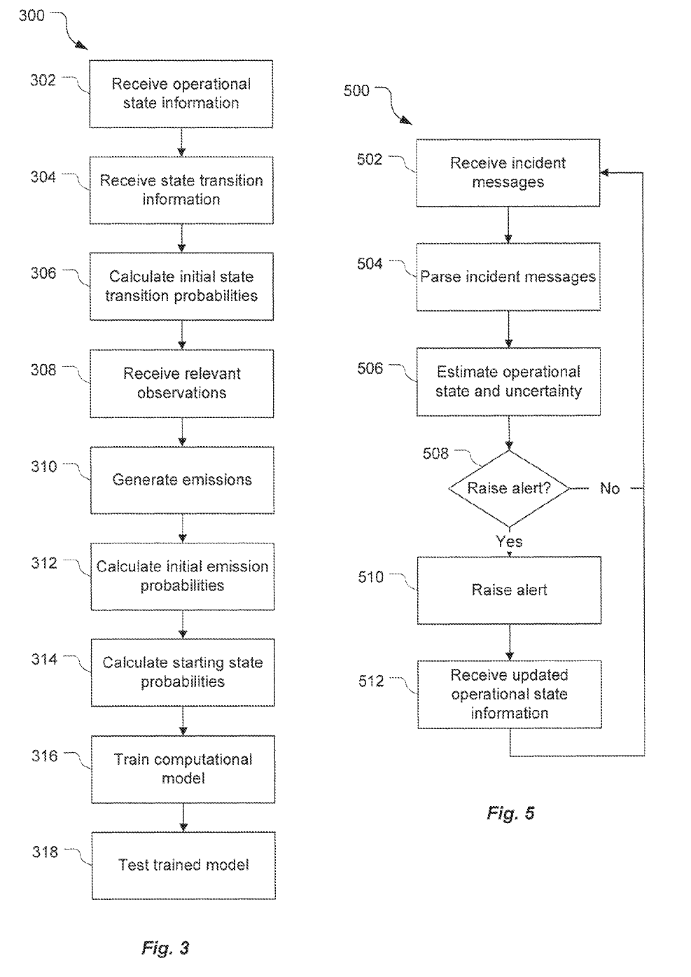

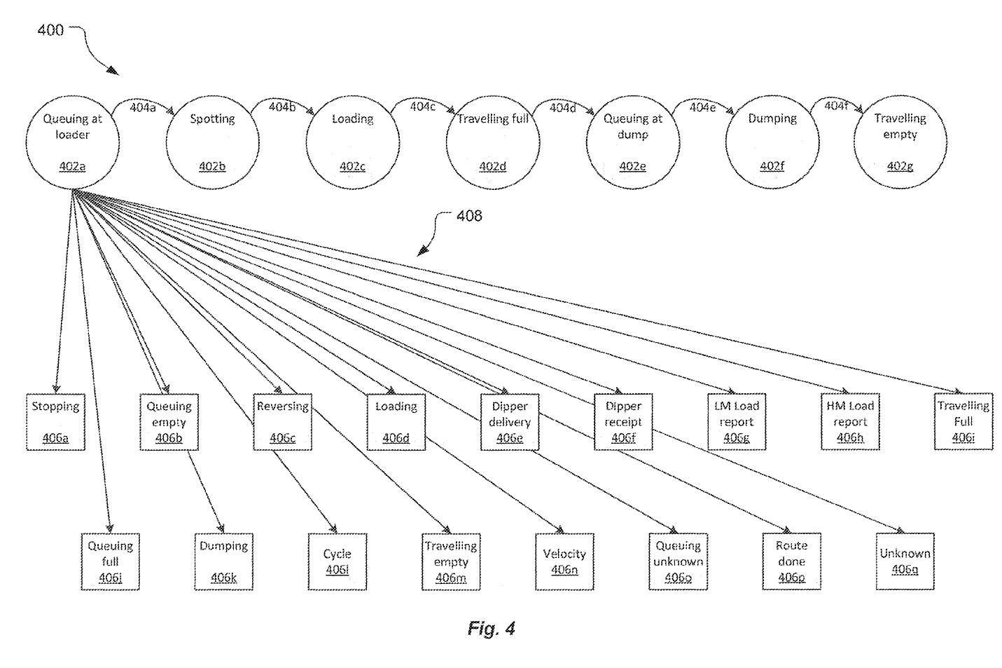

The statistical method implemented by system 202 makes use of a computational model which, in this example, is a Hidden Markov Model (HMM). Alternative Multi-State Modelling techniques could be used, for example other Bayesian Inference techniques based on Markov Chain Monet Carlo Simulations (such as Particle Filters). The process of generating and training the computational model will be described with reference to FIG. 3 (which is a flow chart depicting the computer-implemented method for generating and training a computational model) and FIG. 4 (which provides a partial depiction of a computational model 400—in respect of the haulage machine material transport operation example). Use of the trained computational model to estimate machine states will then be described.

### Generating and Training the Computational Model

At 302, operational state information defining the operational states (402a-402g in FIG. 4) relevant to the operation in question is received. The operational states are determined by an operator and input into computing system 202 using an appropriate input device (e.g. keyboard/mouse, touch screen, etc.) or uploaded to computing system 202 from a memory device. The operational states are the hidden states or variables of the HMM. In this example, the operational states determined to be relevant to the haulage machine material transport operation comprise:
Queuing at the loader (state 402a): i.e. when the haulage machine 102b is at or near the loading machine 102a/loading location 104, and is waiting (potentially in a queue with other haulage machines 102b) to commence loading.
Spotting (state 402b): i.e. when the haulage machine 102b is manoeuvring into the required position to be loaded by the loading machine 102a.
Loading (state 402c): i.e. the haulage machine 102b receiving material from the loading machine 102a.
Travelling full (state 402d): i.e. the haulage machine 102a travelling with a load of material from the loading location 104 to the dump location 106.
Queuing at the dump location 106 (state 402e): i.e. when the haulage machine 102b is at or near the dump location 106, and is waiting (potentially in a queue with other haulage machines 102b) to commence dumping.
Dumping (state 402f): i.e. the haulage machine 102a dumping its load of material at the dump location 106.
Travelling empty (state 402g): i.e. the haulage machine 102a travelling empty from the dump location 106 back to the loading location 104.

At 304, information on possible state transitions (404a-404f in FIG. 4) is received. Possible state transitions are determined by an operator according to the expected transitions between operational states, and are input into/uploaded to computing system 202. In the current example the state transitions identified are:
Queuing at loader→spotting (transition 404a).
Spotting→loading (transition 404b).
Loading→travelling full (transition 404c).
Travelling full→queuing at dump (transition 404d).
Queuing at dump→dumping (transition 404e).
Dumping→travelling empty (transition 404f).

The operation in question may be cyclical. In the present example machines will often transition from travelling empty (state 402g) back to queuing at loader (state 402a). There may, however, also be non-productive operations or states that occur that (at least in this case) are not modelled. Non-productive operations may comprise, for example refuelling operations, maintenance operations, and shift change operations.

At 306, initial transition probabilities are calculated. The transition probabilities indicate the likelihood that the system will move from one state to another. A variety of options exist for this initial calculation, within the general constraint that the sum of the transition probabilities emanating from a given state is 1.0. For example, system 202 may be configured to: randomly calculate initial state transition probabilities; calculate initial state transition probabilities based on received information regarding the operation in question (e.g. sample data regarding its historical performance and/or anticipated future performance); calculate initial state transition probabilities such that each possible transition from a given state has the same transition probability (i.e. for a given state having x possible transitions, the state transition probability for each transition from that state is calculated to be 1/x).

Information on the states 402 and state transition probabilities is stored in a state transition matrix, stored in turn on a memory device accessible by processing unit 204 (e.g. non-transient memory 212). Table 1 provides an example state transition matrix recording initial state transition probabilities for the current haulage machine material transport operation example. For the purposes of the present example, the methodology of calculating each initial state transition probability from a given state to be equal has been adopted. As each state has only one possible transition each initial state transition probability is (in this particular instance) 1.0. As the model is trained (discussed below) the initial transition probabilities are refined.

TABLE 1
Example state transition matrix with initial state transition probabilities.

| State | 402a | 402b | 402c | 402d | 402e | 402f | 402g |
|---|---|---|---|---|---|---|---|
| 402a | 0 | 1 | 0 | 0 | 0 | 0 | 0 |
| 402b | 0 | 0 | 1 | 0 | 0 | 0 | 0 |
| 402c | 0 | 0 | 0 | 1 | 0 | 0 | 0 |
| 402d | 0 | 0 | 0 | 0 | 1 | 0 | 0 |
| 402e | 0 | 0 | 0 | 0 | 0 | 1 | 0 |
| 402f | 0 | 0 | 0 | 0 | 0 | 0 | 1 |
| 402g | 0 | 0 | 0 | 0 | 0 | 0 | 0 |

At 308, types of information that will (or should) be received by system 202 and that are relevant to the operation in question are received. Relevant information to the operation is determined by an operator according to the various incident messages that are expected to be received from the worksite 100 and which are of potential relevance to determining any of the operational states 402. These are input into/uploaded to system 202 by the operator, and are treated as observations of the HMM (see 406a-406q in FIG. 4). In the present example the observations are selected from the following types of observations:
Stopping information as to whether a haulage machine is stopping (observation 406a). This information can be ascertained from a variety of sources, for example speed data, brake sensor data, and/or GPS data received from the haulage machine in question.
Queuing empty information as to whether a haulage machine is queuing empty (observation 406b). This information can be ascertained from a variety of sources, for example load sensor data (such as strut pressure data) and GPS data received from the haulage machine in question, and map information (to determine whether the machine is in a queuing area).
Reversing information as to whether a haulage machine is reversing (observation 406c). This information can be ascertained from a variety of sources, for example speed data, gear sensor data, and/or GPS data received from the haulage machine in question.
Loading information as to whether a haulage machine is being loaded by a loading machine (observation 406d). This information can be ascertained from a variety of sources, for example strut pressure sensor data from the haulage machine in question.
Dipper delivery information as to a loading machine delivering dipper-loads of material to a haulage vehicle (observation 406e). This information can be ascertained from a variety of sources, for example boom instrumentation data and payload monitoring system data from the loading machine in question.
Dipper receipt information as to whether a haulage machine is receiving dipper-loads of material from a loading machine (observation 406f). This information can be ascertained from a variety of sources, for example strut pressure sensor data from the haulage machine in question.
Loading machine load report information indicating the loading of a haulage machine is complete (observation 406g). This information can be ascertained, for example, from a loading machine operator initiated message (sent on activation of a relevant control) indicating the loading of a haulage machine is complete.
Haulage machine load information indicating the settled weight of the haulage machine (observation 406h). This information can be ascertained from a variety of sources, for example strut pressure sensor data, speed sensor data, and gear sensor data from the haulage machine in question. For example, the haulage machine may weigh itself when travelling in 2nd gear and then generate a message as to its load state accordingly.
Travelling full information indicating a haulage machine is travelling loaded (observation 406i). This information can be ascertained from a variety of sources, for example strut pressure sensor data, speed sensor data, and gear sensor data from the haulage machine in question.
Queuing full information indicating a haulage machine is queuing loaded (observation 406j). This information can be ascertained from a variety of sources, for example strut pressure sensor data, GPS data, brake data, and gear sensor data from the haulage machine in question, together with map information (to determine whether the machine is in a queuing area).
Dumping information indicating a haulage machine is dumping (observation 406k). This information can be ascertained from a message indicating a dumping switch has been activated on the haulage machine in question.
Haulage machine cycle information (observation 406l). This can comprise a variety of information obtained from a variety of haulage machine sensors. For example, the machine cycle information may include information such as total time travelling full, total time travelling empty, total time stopped full, total time stopped empty, total distance travelled full, total distance travelled empty, payload, fuel used, and the like.
Travelling empty information indicating a haulage machine is travelling empty (observation 406m). This information can be ascertained from a variety of sources, for example strut pressure sensor data, speed sensor data, and gear sensor data from the haulage machine in question.
Velocity information indicating the velocity of the haulage machine (observation 406n). This information can be ascertained from a variety of sources, for example GPS data and speed sensor data from the haulage machine in question.
Queuing unknown information indicating that the haulage machine is in a queuing area and has stopped, but has an unknown load state (observation 406o). This information can be ascertained from a variety of sources, for example GPS data and gear sensor data from the haulage machine in question together with map data. The unknown load state may, for example, be to malfunctioning or non-existing load sensors/strut pressure sensors, the machine having just started up and not yet sent state information, or missing/late messages from the machine re the load state.
Route done information indicating the haulage machine has completed travelling a path to which it was granted permissions (observation 406p). This information can be ascertained from a variety of sources, for example GPS data received from the haulage machine in question and map information.
Unknown information indicating that the state of the haulage machine is unknown (observation 406q). This may be due, for example, to a machine having just started up and not yet having sent messages, to broken or malfunctioning equipment, or to lost/late messages.

As can be seen, the observations 406 in the present example comprise observations/information from a plurality of separate sources. Separate sources in this case can relate to observations/information derived from different worksite machines. For example, the queuing empty observation/information is sourced from the actual haulage machine 102b whose state is being estimated and the dipper report observation/information is sourced from a loading machine 102a (the haulage machine 102b and loading machine 102a being separate sources of information). Separate sources can also relate to observations/information derived from different sensors or different sensor groups on a given machine 102. For example, the stopping observation/information is sourced from a first sensor/group of sensors carried by the haulage machine 102b whose state is being estimated and the reversing observation/information is sourced from a second, different sensor/group of sensors carried by the haulage machine 102b whose state is being estimate (the first sensor/group of sensors and the second sensor/group of sensors being separate sources). One group of sensors should be considered different to another group of sensors provided there is at least one sensor present in one group and not the other. By way of further example, contextual information available to system 202 regarding the worksite and/or worksite operations may provide a separate source of information. Contextual information may comprise information such as assignment information for a machine in question (i.e. the task currently assigned to a machine), shift-change information (i.e. scheduled shift-change times and locations), map information (i.e. information as to the location of various worksite paths and locations).

The observations 406 also comprise observations made by the actual machine whose state is being estimated as to its own perceived state—e.g. the queuing empty observation 406b (being an observation made by the machine in question that it is in the queuing empty state), the reversing observation 406c, the loading observation 406d, the travelling full observation 406i, the queuing full observation 406j, the dumping observation 406k. These observations are obtained/derived from various sensor measurements. As described above, however, a machine's perception of its own state may be incorrect (e.g. due to faulty or miscalibrated sensors), and/or messages communicated to the control centre and including the self-perceived state information may be compromised which impacts on the reliability of these self-perceived state messages. By taking into account additional observations (both from the machine itself and other machines) system 202 can make a more reliable estimate as to the actual operational state of a machine.

At 310 emissions in respect of the model are generated. In the present embodiment the model is prepared on the assumption that any observation may be made from any state. In FIG. 4 the emissions with respect to the queuing at loader state 402a are indicated by lines 408 extending between state 402a and each of the observations 406. In the complete HMM emissions exist between each state 402 and each observation 406, however in FIG. 4 lines representing emissions from states 402b-402g have been omitted for clarity.

At 312 initial emission probabilities are calculated (i.e. the probability of a given observation 406 occurring whilst in a given state 402). A variety of options exist for this initial calculation within the general constraint that the sum of the emission probabilities emanating from a given state is 1.0. For example, system 202 could be configured to: randomly calculate initial emission probabilities; calculate initial emission probabilities based on received information regarding the operation in question (e.g. information re the historical performance and/or anticipated future performance of the operation); calculate the initial emission probabilities such that each possible emission from a given state has the same emission probability (i.e. for a given state having y possible emissions, the emission probability for each emission from that state is calculated to be 1/y). Typically a rough estimate of emission probabilities (based on experience and judgement) will be entered by a user.

Information on the observations 406, emissions 408, and emission probabilities is stored in an emission probability matrix, stored in turn on a memory device accessible by processing unit 204 (e.g. non-transient memory 212). Table 2 provides an example of a partial emission probability matrix recording initial emission probabilities for the current haulage machine material transport operation example. For the purposes of illustration, the methodology of calculating initial emission probabilities from a given state to be equal has been adopted. Taking the queuing at loader state 402a, as there are 17 possible emissions each emission probability is initially calculated as 1/17.:

TABLE 2
Example emission probability matrix with initial emission probabilities.

| State/ | | | | | | | | |
|---|---|---|---|---|---|---|---|---|
| Observation | 404a | 404b | 404c | 404d | 404e | 404f | 404g | . . . |
| 402a | 1/17 | | | | | | | |
| 402b | 1/17 | | | | | | | |
| 402c | 1/17 | | | | | | | |
| 402d | 1/17 | | | | | | | |
| 402e | 1/17 | | | | | | | |
| 402f | 1/17 | | | | | | | |
| 402g | 1/17 | | | | | | | |

At 314 initial starting state probabilities for the HMM are calculated. Once again a variety of options exist for this initial calculation within the general constraint that the sum of the initial starting state probabilities is 1.0. For example, system 202 may be configured to: randomly calculate initial starting state probabilities; calculate initial starting state probabilities based on received information regarding the operation in question (e.g. its historical performance and/or anticipated future performance); calculate initial starting state probabilities such that each possible state has the same initial starting state probability (i.e. for an operation having z states, the initial starting state probability for each state is calculated to be 1/z).

Information on initial starting state probabilities is stored in a starting state matrix, stored in turn on a memory device accessible by processing unit 204 (e.g. non-transient memory 212). Table 3 provides an example starting state matrix recording initial starting state probabilities for the current haulage machine material transport operation example. For the purposes of the present example, the methodology of calculating initial starting state probabilities to be equal has been adopted. As there are 7 possible states, each initial starting state probability is calculated as 1/7.

TABLE 3
Example starting state matrix with initial
starting state probabilities.

| State | Starting state probability |
|---|---|
| 402a | 1/7 |
| 402b | 1/7 |
| 402c | 1/7 |
| 402d | 1/7 |
| 402e | 1/7 |
| 402f | 1/7 |
| 402g | 1/7 |

At 316 system 202 trains the computational model. In order to train the HMM system 202 is, in the present embodiment, processes the computational model developed (as described above) and a training dataset in accordance with a Baum-Welch algorithm. The training dataset comprises observations from historical implementations of the operation (typically by many machines). Operating system 202 processes the training dataset according to the Baum-Welch algorithm to generate: updated state transition probabilities that reflect the training dataset (stored, for example, in an updated state transition probability matrix on a memory such as 212); updated emission probabilities that reflect the training dataset (stored, for example, in an updated emission probability matrix on a memory such as 212); updated starting state probabilities that reflect the training dataset (stored, for example, in an updated starting state matrix on a memory such as 212).

Generally speaking, the more information comprised in the training dataset the more accurate the HMM will be. Further, the computational model may be periodically retrained if necessary or desired as more observational data is obtained.

At 318, system 202 tests the trained HMM by processing a dataset using the trained HMM to estimate machine operational states based on the observations included in the dataset. In the present embodiment system 202 is configured to process the training dataset and trained HMM using a Viterbi algorithm.

By processing the training dataset and trained HMM using a Viterbi algorithm, regions where the model performs poorly are identified—for example by identifying numeric underflows and overflows in the computation. Where such underflows/overflows are identified, system 202 is configured to interpret this as indicating that the process has become non-stationary. In this case system 202 splits the problem into separate regions and processes each region separately (e.g. by separately processing each region using a Viterbi algorithm).

From the testing of the trained HMM at 318, system 202 calculates both operational state estimations based on the observations and, for each estimated operational state, an associated operational state uncertainty indicating the probability that the estimated state is accurate.

While FIG. 3 is depicted as linear flow chart it will be appreciated that the various operations need not necessarily be performed in the order depicted. As one example, the system could be configured to receive the relevant information on the operational states (at 302) and relevant observations (at 308) could well be received in a different order or in parallel.

### Estimating Machine Operational State

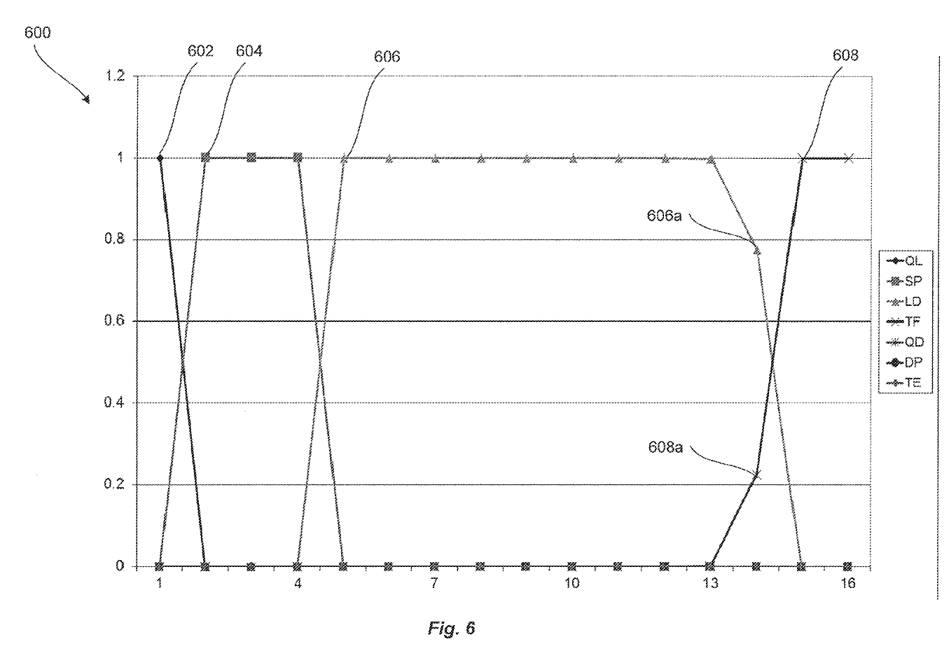

FIG. 5 provides a flowchart 500 depicting the computer-implemented method for using the computational model to estimate the operational state of a particular machine. Once again, the process will be described in relation to the example haulage machine material transport operation.

At 502, system 202 receives incident messages from the worksite 100. At 504, system 202 parses the incident message to extract observational data and machine identification information (identifying the particular machine that the observational data relates or is thought to relate to). Each item of observational data matches an observation 406 included in the model 400 generated in respect of the operation.

At 506, system 202 processes the observational data relevant to the machine in question using the trained HMM. In the present embodiment system 202 is configured to process the observational data and HMM using a Viterbi algorithm which generates an estimate as to the current operational state of the machine in question, together with an associated operational state uncertainty indicating the probability that the estimated state is correct.

At 508 system 202 processes the estimated operational state and associated uncertainty against alert criteria to determine whether an alert needs to be raised.

By way of example, the alert criteria may be that a predefined number of state estimates are made in a row with each state estimate having an uncertainty the exceeds a predefined threshold. E.g., if four state estimates are made each of which having an uncertainty of greater than 20% an alert is raised.

In the context of reporting on worksite operations, an alert may simply be raised where the uncertainty associated with an identified state exceeds a threshold (e.g. any identified state with an uncertainty of greater than 20% is flagged for review). Flagging uncertain states in this manner reduces the workload of human operators reviewing such reports, insofar as instead of checking all reported states to see if they are correct/appear sensible, only those states which are flagged need to be reviewed.

If the alert criteria are not satisfied, no alert is raised and process returns to 502 to receive/process further incident messages.

If the alert criteria are satisfied, system 202 raises an alert at 510. In the present embodiment system 202 is configured to raise an alert by displaying an alert message on a display for a control centre operator to view and action. Alerts may, of course, be raised to additional or alternative human operators and/or in additional or alternative ways. For example, depending on the operation in question and the alert to be raised, system 202 may alert a control centre operator, a worksite overseer, and/or one or more a machine operators. Human operators may be alerted by (again by way of non-limiting example): displaying an alert on a display; generating and sending an email to one or more email addresses; generating and sending a SMS to one or more phone numbers; generating and sending an instant message to one or more instant message addresses.

On receiving an alert, an operator takes the appropriate action. Typically this will be to review the currently recorded operational state of the machine in question and, if required, manually correct it. The operator may determine the actual state of the machine in question in a number of ways. For example, the operator may: observe real time footage of the machine (received, for example, by an appropriately positioned on-site video camera); contact the operator of the machine; contact another on-site operator with knowledge of the operational state of the machine in question.

In some embodiments, the trigger of an alert may result in additional analysis of worksite information being performed in order to determine the likely state of the machine in question. For example, if an alert is raised due to a low confidence that a haulage machine is loading at a nominated loading machine, the system 202 may process additional information (e.g. the locations of the loading and haulage machines, the proximity of the loading and haulage machines to one another, assigned destination of the haulage machine, any other potentially relevant worksite information) to try and determine the likely actual state of the haulage machine.

At 512, updated operational state information is received and recorded by system 202.

Process 500 can be performed in real time, in the sense that incident messages are processed as they are received from the worksite 100 and if an alert is to be raised it is raised as soon as that has been determined. Automatically flagging operational state alerts and allowing misidentified operational states to be corrected in real time provides for far greater efficiencies than having operators manually inspect the relevant data in batches (e.g. on a per-shift basis, which can involve hundreds of operational cycles) to identify and correct any errors. Identifying and correcting operational state errors in real time can also be beneficial as a misidentified operational state for a given machine can adversely impact the identification of future operational states for that machine, as well as the identification of operational states of other machines.

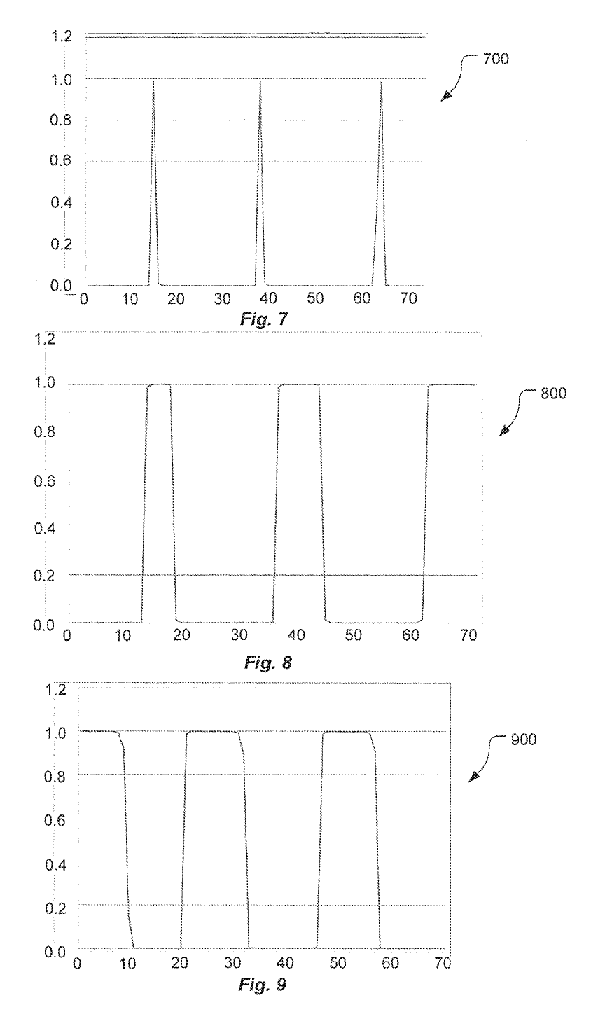

FIGS. 6 to 9 show graphs indicating the operational states and associated uncertainties of a machine calculated according to the above process. The y-axis of each graph shows the level of certainty of the identified state and the x-axis of each graph indicates in chronological order the observations (e.g. messages) from which the states are identified.

FIG. 6 shows an extract of a graph 600 identifying the operational states over a given period (i.e. a given number of observations). The operational states depicted in FIG. 6 comprise: QL—queuing at the loader (state 402a) indicated by the graph line with diamond data points 602; SP—spotting (state 402b) indicated by the graph line with square data points 604; LD—loading (state 402c) indicated by the graph line with triangular data points 606; TF—travelling full (state 402d) indicated by the graph line with cross data points 608. As can be seen: at observation point 1 (as indicated by the x-axis) the operational state of the machine has been determined to be queuing at the loader with a probability of 100% (all other operational states lying on the x-axis itself, i.e. having a 0% probability); at observation points 2 to 4 the operational state of the machine has been determined to be spotting with a probability of 100% (all other operational states having a 0% probability); at observation points 5 to 13 the operational state of the machine has been determined to be loading with a probability of 100% (all other operational states having a 0% probability); at observation points 15 and 16 the operational state of the machine has been determined to be travelling full with a probability of 100% (all other operational states having a 0% probability). At observation point 14 the operational state of the machine has been determined to be loading with a probability of approximately 78% (per data point 606a) or to be travelling full with a probability of approximately 22% (per data point 608a) (with all other operational states having a 0% probability).

FIG. 7 shows a graph 700 indicating the identification the queuing at loader state only: i.e. over the course of the time period plotted the probability that the machine in question was queuing at the loader. As can be see, for example, at around observation point 15 the state of the machine was determined to be queuing at the loader with almost 100% certainty (almost 1.0 on the y-axis).

FIG. 8 shows a graph 800 indicating the identification the spotting state only: i.e. over the course of the time period plotted the probability that the machine in question was spotting.

FIG. 9 shows a graph 900 indicating the identification the loading state only: i.e. over the course of the time period plotted the probability that the machine in question was loading.

As noted above, machines may at various times perform non-productive operations (e.g. refuelling operations, maintenance operations, shift change operations) which need not necessarily be modelled. Non-productive operations can be accounted for either manually or automatically.

For example, when a machine commences a non-productive operation an operator can place the machine on a “delay” (where modelling of the machine's behaviour ceases) while the machine is undertaking non-productive operations. Once the machine has completed non-productive operations the delay can be removed and modelling of the machine's state recommenced. For example, after dumping a haulage machine may need to be refuelled. In this case the operator is notified (or observes) that the machine is performing a non-productive operation and places a delay on the machine to cease modelling. When the operator is informed (or observes) that the machine has refuelled and is returning to a productive operation state (e.g. travelling empty) the operator removes the delay and modelling of the machine's state recommences.

Alternatively, non-productive states may be handled automatically. This may be done, for example, by using the model to identify discrepancies in the machine's behaviour (i.e. significant departures from the expected machine state/state transitions) and using those discrepancies automatically identify that the machine has commenced non-productive operations. The discrepancies may be used with additional information to assist in this determination. For example, location information may indicate that the machine is attending a refuelling location, a maintenance location, or a shift-change location (indicating, respectively, that the machine is refuelling, undergoing maintenance, or changing driver). Fuel level information may indicate that the machine is running out of fuel, in turn indicating that a refuelling operation may be in progress.

### Use of Operational State Information

As noted above, accurate information as to the particular operational state of a specific machine 102 at a given time can be analysed to generate information on the performance of the worksite 100 and/or the performance of individual worksite operators/machines.

For example, in the haulage machine material transportation example described above, accurate operational state information on the individual haulage machines 102b involved may be useful to assess one or more of the following:
Poor/exceptional haulage machine operator performance. For example, by analysing the operational state information, together with information as to which machine operator was scheduled to be operating the machine at the relevant time, the average time spent spotting by that particular driver can be determined. This can then be compared, for example, to an maximum spotting time threshold and an alert raised if the driver exceeds the maximum spotting time threshold (potentially indicating poor performance), or beats a minimum spotting time threshold (potentially indicating good performance). Alternatively, the spotting time of an individual driver can be compared against the average spotting time taken for all drivers, and alerts raised based on deviation from the average.
Poor/exceptional loading machine operator performance. For example, if the operational state information shows that the average time spent by haulage machines in the loading state exceeds an acceptable value (or exceeds the average time spent by haulage machines being loaded by another loading machine/driver by a defined amount) this may be an indication of poor performance of the loading machine operator. Similarly, if the operational state information shows that a particular loading machine driver consistently beats an expected loading time, this may indicate good performance.
Machine sensor fault. If a worksite machine is regularly reporting information that does not reflect its actual operational state, this may be an indication that one or more sensors on the machine are faulty. This, in turn, may lead to a maintenance request being generated for the relevant machine (and, if identified, particular sensor/s).
Worksite loading location condition. If all (or a set percentage) of haulage machine operators exceed an acceptable spotting time threshold, or the operational state data indicates that over time the average spotting time is increasing, this may indicate poor worksite conditions at the loading location 104. This may, in turn, be used to schedule worksite maintenance to the loading location 104.
Worksite road condition. If all (or a set percentage) of haulage machine operators exceed an acceptable travelling full (or empty) time threshold, or the operational state data indicates that over time the average travelling full (or empty) time is increasing, this may indicate poor road conditions on the worksite roads traversed while travelling full (or empty). This may, in turn, be used to schedule worksite maintenance to the relevant worksite roads 112.
Worksite improvement possibilities. For example if machines are underperforming in particular locations this may indicate that those locations can be improved, for example by changing ramp designs or the like.
General machine utilization/site productivity optimisation. Knowledge of the actual state of a given machine can be used to determine what a machine should be doing next.

### Application to Other Operations

The processes described above can, of course, be applied to worksite operations involving alternative operational states, state transitions, and observations.

For example, the process may be for a short-haul operation involving the transfer of material from a stockpile to a crusher. In this case: the relevant operation states may be identified as loading, hauling, and dumping. Other operations may be related to dozer, drill, dragline, water truck activities and cycles. For each different operation the relevant states, state transitions and observations are selected and an appropriate HMM generated, trained, tested and used to estimate the operational states of machines using the processes described above.

Disclosed herein is a computer-implemented method for estimating an actual operational state of a machine of interest at a point in time, the machine of interest being involved in a worksite operation comprising a plurality of different operational states, wherein the method comprises operating a computer processing unit to: receive a plurality of messages, each message comprising data relating to the machine of interest as it performs the worksite operation, the plurality of messages comprising data from at least two separate sources; process the data from the plurality of messages using a statistical process to generate an estimated actual operational state of the machine of interest at the point in time. The at least two separate data sources may comprise a first data source comprising data derived from a first sensor carried by the machine of interest and a second data source comprising data derived from a second sensor carried by the machine of interest. The at least two separate data sources comprise a first data source comprising data derived from the machine of interest and a second data source comprising data derived another worksite machine. The at least two separate data sources comprise a data source of contextual information. The plurality of messages may comprise at least one perceived state message comprising data relating to a perceived operational state of the machine of interest at a point in time. The source of the at least one perceived state message may be the machine of interest. The computer-implemented method may further comprise operating the computer processing unit to: process the estimated actual operational state against alert criteria; and responsive to the alert criteria being satisfied, raise an alert comprising at the estimated actual operational state of the machine of interest. The computer-implemented method may further comprise operating the computer processing unit to: process the plurality of operation messages using the statistically based process to generate uncertainty information associated with the estimated actual operational state of the machine of interest at the point in time, the uncertainty information defining an uncertainty with respect to the estimated actual operational state of the machine of interest at the point in time, and wherein the uncertainty information associated with the estimated actual operational state is used in the processing of the estimated actual operational state against the alert criteria. The computer processing unit may be operated to: receive the plurality of messages in real time; and process the plurality of messages in real time such that the estimated actual operational state of the machine of interest is generated in real time. The computer implemented method may further comprise operating the computer processing unit to: generate a computational model of the worksite operation, the computational model comprising the plurality of different operational states and plurality of observations relevant to the plurality of operational states, wherein each of the plurality of messages comprises data relating to an observation, and wherein processing the data from the plurality of messages using the statistical process comprises processing the data using the computational model to estimate the actual operational state of the machine of interest. The computer-implemented method may further comprise operating the computer processing unit to train the computational model using a training dataset. The computational model may comprise a Hidden Markov Model and the operational states may be hidden states of the Hidden Markov Model. Processing the data from the plurality of messages using the statistical process may comprise using a Viterbi Algorithm to process the data using the computational model to estimate the actual operational state of the machine of interest. The worksite process may comprise operating haulage machines to haul material from a loading location to a dumping location, and the machine of interest may a particular haulage machine. The plurality of different operational states may comprise: the machine of interest queuing at a loading location; the machine of interest spotting; the machine of interest loading; the machine of interest travelling full; the machine of interest queuing at a dumping location; the machine of interest dumping; the machine of interest travelling empty.

It will be understood that the invention disclosed and defined in this specification extends to all alternative combinations of two or more of the individual features mentioned or evident from the text or drawings. All of these different combinations constitute various alternative aspects of the invention.

1. A computer-implemented method for estimating an actual operational state of a machine of interest at a point in time, the machine of interest being involved in a worksite operation comprising a plurality of different operational state), wherein the method comprises operating a computer processing unit to:
receive a plurality of messages, each message comprising data relating to the machine of interest as it performs the worksite operation, the plurality of messages comprising data from at least two separate sources; and
process the data from the plurality of messages using a statistical process to generate an estimated actual operational state of the machine of interest at the point in time.

2. A computer-implemented method according to claim 1, wherein the at least two separate data sources comprise a first data source comprising data derived from a first sensor carried by the machine of interest and a second data source comprising data derived from a second sensor carried by the machine of interest.

3. A computer-implemented method according to claim 1, wherein the at least two separate data sources comprise a first data source comprising data derived from the machine of interest and a second data source comprising data derived another worksite machine.

4. A computer-implemented method according to claim 3, wherein the plurality of messages comprise at least one perceived state message comprising data relating to a perceived operational state of the machine of interest at a point in time.

5. A computer-implemented method according to claim 1, further comprising operating the computer processing unit to:
process the estimated actual operational state against alert criteria; and
responsive to the alert criteria being satisfied, raise an alert comprising at least the estimated actual operational state of the machine of interest.

6. A computer-implemented method according to claim 5, further comprising operating the computer processing unit to:
process the plurality of operation messages using the statistically based process to generate uncertainty information associated with the estimated actual operational state of the machine of interest at the point in time, the uncertainty information defining an uncertainty with respect to the estimated actual operational state of the machine of interest at the point in time, and wherein
the uncertainty information associated with the estimated actual operational state is used in the processing of the estimated actual operational state against the alert criteria.

7. A computer implemented method according to claim 1, further comprising operating the computer processing unit to:
generate a computational model of the worksite operation, the computational model comprising the plurality of different operational states and plurality of observations relevant to the plurality of operational states, wherein each of the plurality of messages comprises data relating to an observation, and wherein
processing the data from the plurality of messages using the statistical process comprises processing the data using the computational model to estimate the actual operational state of the machine of interest.

8. A computer-implemented method according to claim 7, wherein the computational model comprises a Hidden Markov Model and the operational states are hidden states of the Hidden Markov Model.

9. A computer processing system configured to estimate an actual operational state of a machine of interest at a point in time, the machine of interest being involved in a worksite operation comprising a plurality of different operational states, the computer processing system configured to:
receive a plurality of messages, each message comprising data relating to the machine of interest as it performs the worksite operation, the plurality of messages comprising data from at least two separate sources; and
operate a processing unit to process the data from the plurality of messages using a statistical process to generate an estimated actual operational state of the machine of interest at the point in time.

10. A non-transitory computer-readable medium comprising instructions which, when implemented by a computer processing system, cause the computer processing system to estimate an actual operational state of a machine of interest at a point in time, the machine of interest being involved in a worksite operation comprising a plurality of different operational states, the instructions causing the computer processing system to:
receive a plurality of messages, each message comprising data relating to the machine of interest as it performs the worksite operation, the plurality of messages comprising data from at least two separate sources; and
process the data from the plurality of messages using a statistical process to generate an estimated actual operational state of the machine of interest at the point in time.
